(19) United States
(12) Patent Application Publication
(10) Pub. No.: US 2024/0112307 A1
(43) Pub. Date: Apr. 4, 2024

(54) IMAGE PROCESSING DEVICE AND IMAGE DISPLAY DEVICE

(71) Applicant: LAPIS Technology Co., Ltd., Yokohama (JP)

(72) Inventors: Naoki NISHITANI, Yokohama (JP); Yuki IMATOH, Yokohama (JP)

(73) Assignee: LAPIS Technology Co., Ltd., Yokohama (JP)

(21) Appl. No.: 18/469,922

(22) Filed: Sep. 19, 2023

(30) Foreign Application Priority Data
Sep. 30, 2022 (JP) 2022-158387

(51) Int. Cl. G06T 5/50; G06T 5/00

(52) U.S. Cl. CPC G06T 5/50; G06T 5/002; G06T 5/003; G06T 2207/20021; G06T 2207/20192; G06T 2207/20212; G06T 2207/30252

(57) ABSTRACT

An image processing device has an emphasis processing unit configured to generate an emphasized image yielded by performing an emphasis process on an image captured of surroundings of a vehicle, a smoothing unit configured to generate a smoothed image yielded by performing a smoothing process on the image, and a combination unit configured to generate, for each region of the image, a display image to be displayed in a display using any of the smoothed image, emphasized image, and the image.

### CROSS REFERENCE TO RELATED APPLICATION

This application is based upon and claims the benefit of priority of the prior Japanese Patent Application No. 2022-158387, filed on Sep. 30, 2022, the entire contents of which are incorporated herein by reference.

### TECHNICAL FIELD

The disclosure relates to an image processing device and an image display device.

### BACKGROUND ART

In recent years, a technique of performing display using so-called electronic mirrors, in which footage from cameras installed at the rear and sides of the vehicle are displayed in a display, instead of using the rear-view mirror and side mirrors to allow a driver to see the surroundings of a vehicle, is being used. Display using such electronic mirrors allows the driver to see areas that would not be visible with a conventional mirror, presenting the advantage of allowing for safer driving.

However, there has been the problem that the eyes of the driver who is driving the vehicle are focused at a point far in the distance during driving, and thus, when viewing the display, it takes time for the driver's eyes to focus on the display. Additionally, with increasing age, it takes more time for the driver's eyes to focus, which presents the problem that drivers of advanced age in particular tend to find it difficult to view the display.

A vehicle-installed image processing device that blurs a portion of the region of a display image other than the region to which the driver should pay attention, in order to reduce confusion for the driver has been proposed (e.g., Japanese Patent Application Laid-Open Publication No. 2019-125894). Also, a vehicle-installed imaging system displays an expanded image of a partial region in the display range (e.g., Japanese Patent Application Laid-Open Publication No. 2014-192777).

### SUMMARY

Methods such as the above-mentioned conventional technique of blurring regions other than those to which the driver should be paying attention have presented the problem of a lack of sufficient visibility for the region to which the driver should pay attention. In particular, if the speed of the host vehicle is high, then it becomes difficult for the driver to ascertain the distance to other vehicles, thus presenting the problem that if display of other vehicles is not clear, then driving safety cannot be sufficiently improved.

Also, in the method of displaying an expanded image of a partial region, the image size is changed to match the visual field of the driver, and thus, there is a need to change the perspective to match the change in image size, which presents the problem that it takes time for the eyes to adjust the focus.

The disclosure takes into consideration the above problem, and an object thereof is to provide an image processing device by which it is possible to display images with high visibility while reducing confusion for the driver when viewing the images.

An image processing device according to the disclosure includes: an emphasis processing unit configured to generate an emphasized image yielded by performing an emphasis process on an image captured of surroundings of a vehicle; a smoothing unit configured to generate a smoothed image yielded by smoothing the image; and a combination unit configured to generate, for each region of the image, a display image to be displayed in a display using any of the smoothed image, the emphasized image, and the image.

An image processing device according to the disclosure includes: a sharpening unit configured to generate a sharpened image yielded by sharpening edges of an image captured of surroundings of a vehicle; a priority calculation unit configured to calculate a degree of priority of the sharpening for each of a plurality of partitioned regions into which the image is divided; and a combination unit configured to select, for each pixel, whether to use the image or the sharpened image on the basis of the degree of priority, to generate a display image to be displayed in a display.

A display device according to the disclosure includes: an image acquisition unit configured to acquire an image captured of surroundings of a vehicle; a display unit configured to display a display image based on the image; and an image processing unit configured to perform image processing on the image to generate the display image, wherein the image processing unit includes: an emphasis processing unit configured to generate an emphasized image yielded by performing an emphasis process on the image; a smoothing unit configured to generate a smoothed image yielded by performing a smoothing process on the image; and a combination unit configured to generate, for each region of the image, the display image using any of the smoothed image, the emphasized image, and the image.

A display device according to the disclosure includes: an image acquisition unit configured to acquire an image captured of surroundings of a vehicle; a display unit configured to display a display image based on the image; and an image processing unit configured to perform image processing on the image to generate the display image, wherein the image processing unit includes: a sharpening unit configured to generate a sharpened image yielded by sharpening edges of the image; a priority calculation unit configured to calculate a degree of priority of the sharpening for each of a plurality of partitioned regions into which the image is divided; and a combination unit configured to select, for each pixel, whether to use the image or the sharpened image on the basis of the degree of priority, to generate the display image.

### BRIEF DESCRIPTION OF THE DRAWINGS

FIG. 1 is a block diagram showing a configuration of an image processing device of the present embodiment.

FIG. 2 is a block diagram showing an internal configuration of an image correction LSI.

FIG. 3A shows an example of sharpening and smoothing processes performed for each partitioned region.

FIG. 3B shows an example of sharpening and smoothing processes performed for each partitioned region.

FIG. 3C shows an example of sharpening and smoothing processes performed for each partitioned region.

FIG. 4 shows the distance from a vehicle and vehicular speed in relation to the sharpening and smoothing processes.

### DETAILED DESCRIPTION OF EMBODIMENTS

A suitable embodiment of the disclosure will be explained below in detail. In the description of an embodiment and the affixed drawings below, parts that are substantially the same or equivalent to each other are assigned the same reference characters.

According to the image processing device of the disclosure, it is possible to display images with high visibility while reducing confusion for the driver.

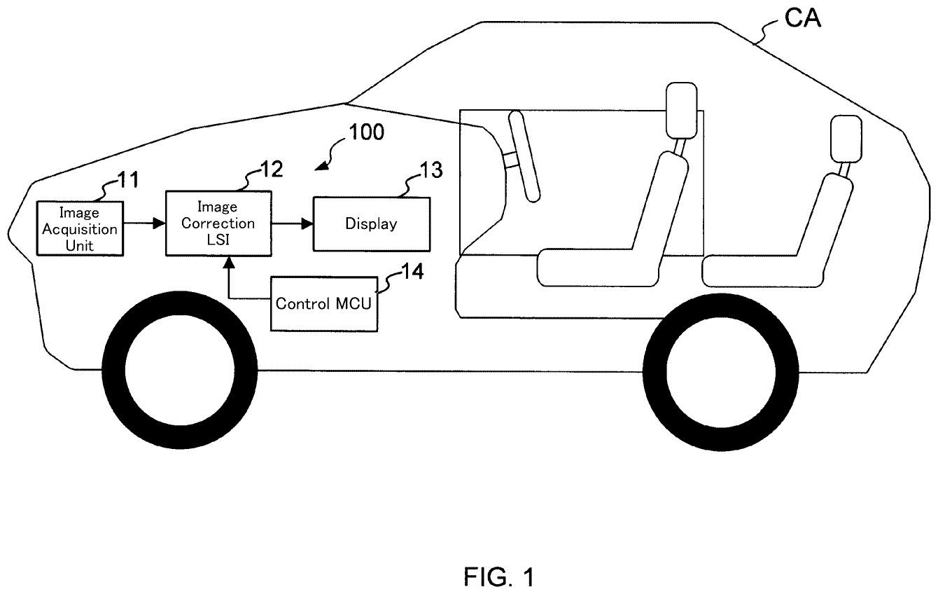

FIG. 1 is a block diagram showing a configuration of an image display system 100 of the disclosure. The image display system 100 is installed in a vehicle CA, and displays images captured of the surroundings of the vehicle CA.

The image display system 100 has an image acquisition unit 11, an image correction LSI 12, a display 13, and a control MCU 14.

The image acquisition unit 11 is constituted of a vehicle-installed camera installed in the vehicle CA, for example, and is fixed at a prescribed attachment position on the body of the vehicle CA in order to capture the surroundings of the vehicle CA. The image acquisition unit 11 supplies an image signal from capturing the surroundings of the vehicle to the image correction LSI 12 as an input image VS.

The image correction LSI (large scale integration) 12 is a circuit unit that performs correction processing on the input image VS supplied from the image acquisition unit 11. Specifically, the image correction LSI 12 performs correction processing for displaying with emphasis a region of a portion of the input image VS (hereinafter referred to as the emphasis process). In the present embodiment, a case will be described below in which a sharpening process of emphasizing edges is performed as an example of the emphasis process. The image correction LSI 12 supplies to the display 13 image data yielded by subjecting the input image VS to correction processing, as an output image VD.

The display 13 is constituted of a liquid crystal display device, for example, and displays the output image VD outputted from the image correction LSI 12.

The control MCU (microcontroller unit) 14 is a control unit that controls the image correction process by the image correction LSI 12. The control MCU 14 controls the image correction process by the image correction LSI 12 on the basis of the speed information of the vehicle CA acquired by a vehicular speed sensor installed in the vehicle CA, for example.

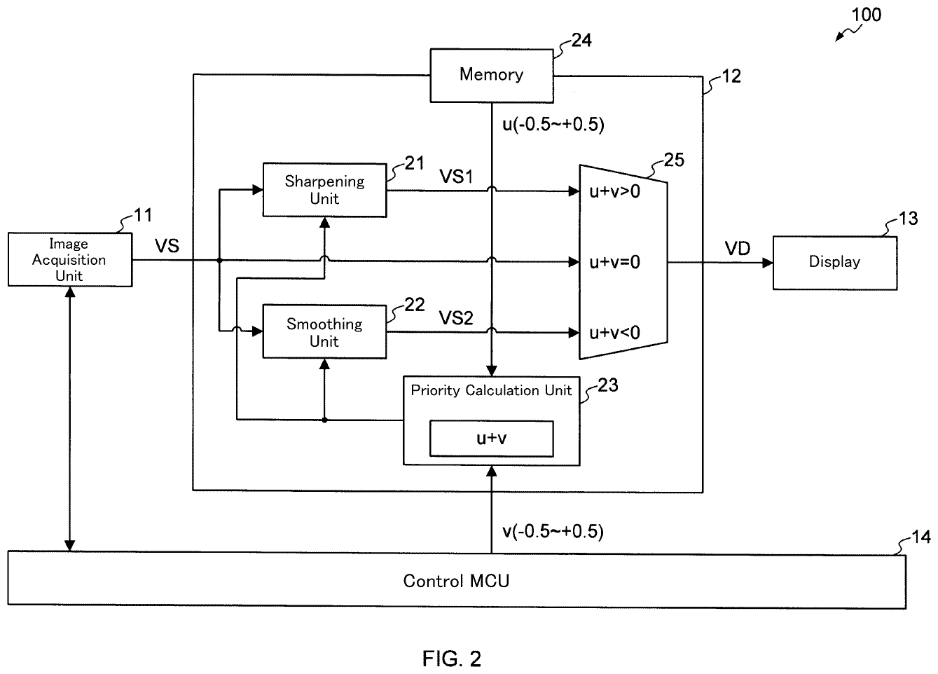

FIG. 2 is a block diagram showing a configuration of the image correction LSI 12. The image correction LSI 12 includes a sharpening unit 21, a smoothing unit 22, a priority calculation unit 23, a memory 24, and a combination unit 25.

The sharpening unit 21 is a processing unit that performs a sharpening process of emphasizing the edges of the input image VS. The sharpening unit 21 performs the sharpening on the input image VS while changing the gain (degree) of sharpening according to the degree of priority calculated by the priority calculation unit 23. The sharpening unit 21 provides the processing results as a sharpened image VS1 to the combination unit 25.

The sharpening unit 22 is a processing unit that smooths the input image VS. The smoothing unit 22 performs the smoothing using a Gaussian filter, for example. The smoothing unit 22 performs the smoothing on the input image VS while changing the gain (degree) of smoothing according to the degree of priority calculated by the priority calculation unit 23. The smoothing unit 22 provides the processing results as a smoothed image VS2 to the combination unit 25.

The priority calculation unit 23 calculates the degree of priority for sharpening and smoothing on the basis of speed information “v” of the vehicle CA supplied from the control MCU 14 and priority region information “u” read from the memory 24, and supplies the calculation results to the sharpening unit 21, the smoothing unit 22, and the combination unit 25. In the present embodiment, the speed information “v” and the priority region information “u” are expressed as relative values in a range of “−0.5” to “+0.5” in relation to a reference value of 0. The priority calculation unit 23 calculates “u+v” to calculate the degree of priority.

If, for example, u+v>0, then the degree of priority of the sharpening process is high. If u+v<0, then the degree of priority of the smoothing process is high. If u+v=0, the degree of priority is the same for sharpening and smoothing, or in other words, the original input image VS subjected to neither process is prioritized.

In the present embodiment, the degree of priority is calculated such that, within the display region of a full screen of the image displayed in the display 13, sharpening is typically prioritized over smoothing for regions that are close to the vehicle body, and smoothing is typically prioritized over sharpening for regions that are far from the vehicle body.

In the present embodiment, the degree of priority is calculated such that if the vehicular speed is high, sharpening and smoothing are prioritized, and if the vehicular speed is low, sharpening and smoothing are deprioritized. In other words, the degree of priority is calculated such that if the vehicular speed is high, then among the plurality of partitioned regions, regions with a high degree of priority for sharpening are given even higher priority for sharpening, and regions with a high degree of priority for smoothing are given even higher priority for smoothing. On the other hand, if the vehicular speed is low, then the degree of priority is calculated such that for both regions with a high degree of priority for sharpening and regions with a high degree of priority for smoothing, the degree of sharpening and smoothing is reduced (that is, sharpening and smoothing are both performed to a small degree).

The memory 24 is a non-volatile semiconductor memory provided inside or outside of the image correction LSI 12, and is constituted of a NAND or NOR serial flash memory, for example. The memory 24 stores the priority region information “u” that is information on the degree of priority for sharpening and smoothing for each partitioned region.

In the present embodiment, a degree of priority “u” is set for each of the six partitioned regions into which a full screen of the display region is divided. The screen is divided into two sections vertically (upper section, lower section) and is divided into three sections horizontally (left, center, and right) to form the six partitioned regions, for example. Among the partitioned regions, the lower center region is typically a region relatively close to the vehicle body, and thus, is set in advance as a region with a high degree of priority for sharpening. The upper left and right regions are typically regions relatively far from the vehicle body, and thus, are set in advance as regions with a high degree of priority for smoothing. The lower left and right regions and the upper center regions are typically regions of intermediate distance from the vehicle body, and thus, are set in advance as regions with an intermediate degree of priority for sharpening and smoothing.

The combination unit 25 generates the output image VD that is displayed in the display 13 on the basis of the input image VS supplied from the image acquisition unit 11, the sharpened image VS1 supplied from the sharpening unit 21, and the smoothed image VS2 supplied from the smoothing unit 22. The combination unit 25 generates the output image VD by using any of the input image VS, the sharpened image VS1, and the smoothed image VS2 for each region of the image.

In the present embodiment, for example, the combination unit 25 selects, for each pixel, whether to use the input image VS, the sharpened image VS1, or the smoothed image VS2 on the basis of the degree of priority information calculated by the priority calculation unit 23. By combining the selected pixels to form an image, the overall output image VD is generated.

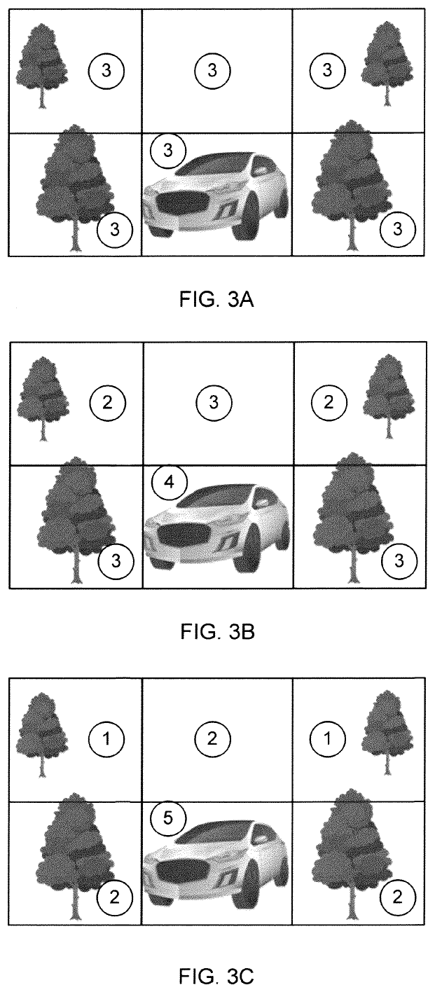

FIGS. 3A to 3C show examples of sharpening and smoothing processes performed for each partitioned region. Here, the degree of sharpening is represented in five degrees 1-5 as the “degree of emphasis.” That is, if the degree of sharpening is high, the value of the degree of emphasis approaches “5,” and if the degree of smoothing is high, the value of the degree of emphasis approaches “1.”

In the description below, cases in which the vehicular speed is less than a first reference value are referred to as low speed, cases in which the vehicular speed is greater than or equal to the first reference value and less than a second reference value are referred to as intermediate speed, and cases in which the vehicular speed is greater than or equal to the second reference value are referred to as high speed.

FIG. 3A shows the degree of emphasis for each partitioned region for a case in which the speed of the vehicle CA is low. If the vehicular speed is low, then the degree of emphasis is uniformly “3” for all of the partitioned regions, and the image is close to the original input image VS not subjected to sharpening or smoothing.

FIG. 3B shows the degree of emphasis for each partitioned region for a case in which the speed of the vehicle CA is intermediate. If the vehicular speed is intermediate, then the lower center region has a degree of emphasis of “4,” the upper right and upper left regions have a degree of emphasis of “2,” and the upper center, lower right, and lower left regions have a degree of emphasis of “3.”

FIG. 3C shows the degree of emphasis for each partitioned region for a case in which the speed of the vehicle CA is high. If the vehicular speed is high, then the lower center region has a degree of emphasis of “5,” the upper right and upper left regions have a degree of emphasis of “1,” and the upper center, lower right, and lower left regions have a degree of emphasis of “2.”

As described above, the lower center region is typically a region relatively close to the body of the vehicle CA, and thus, is set as a region with a high degree of priority for sharpening. The upper right and left regions are typically regions relatively far from the body of the vehicle CA, and thus, are set as regions with a high of priority for smoothing. The upper center, lower right, and lower left regions are typically regions of intermediate distance from the body of the vehicle CA, and thus, are set as regions with an intermediate degree of priority for sharpening and smoothing.

As described above, if the vehicular speed is low, sharpening and smoothing are deprioritized, and if the vehicular speed is high, sharpening and smoothing are prioritized. Thus, in FIG. 3A with a low vehicular speed, image correction is performed such that there is no difference between regions, and the emphasis level is uniform. If the vehicular speed is high as in FIG. 3B, then the degree of emphasis is high for a region with a high degree of priority for sharpening, and the image in such a region is displayed with sharp emphasis. If the vehicular speed is even higher as in FIG. 3C, then the region with a high degree of priority for sharpening is displayed with even greater emphasis. In other words, as the vehicular speed increases, image correction is performed such that the contrast between sharpened regions and smoothed regions is greater.

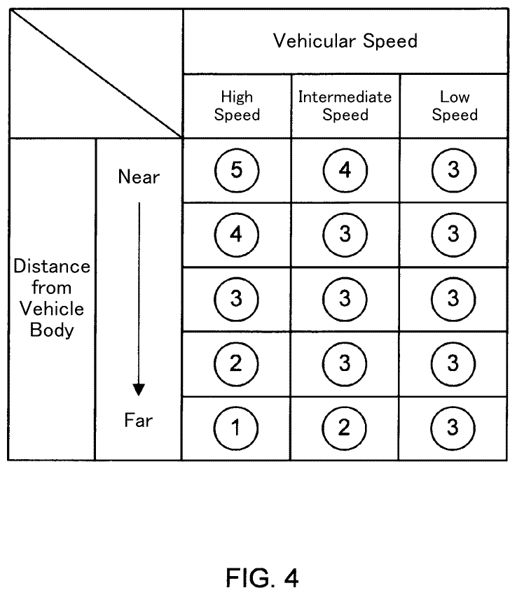

FIG. 4 shows the distance from a vehicle and vehicular speed in relation to the degree of emphasis. If the vehicular speed is low, then the degree of emphasis is uniformly “3” regardless of the distance from the vehicle body. If the vehicular speed is intermediate, then regions close to the vehicle body have a degree of emphasis of “4,” regions far from the vehicle body have a degree of emphasis of “2,” and other regions have a degree of emphasis of “3.” In other words, for regions close to the vehicle body, sharpening is performed to a given level, and for regions far from the vehicle body, smoothing is performed to a given level. If the vehicular speed is high, then the degrees of emphasis are set to various values from “1” to “5” according to the distance from the vehicle body. In other words, sharpening and smoothing are performed according to the distance from the vehicle body, and the difference in the degree of emphasis increases.

As demonstrated with the image display system 100 of the present embodiment, in a vehicle-installed image display system that displays images captured of the surroundings of the vehicle CA, it is possible for the driver to see, in a short period of time, only the regions necessary to view, by displaying display regions to which a driver should pay attention with emphasis displaying other regions so as to be blurry.

By generally setting the degree of emphasis to be high for regions in which it is assumed that the distance from the vehicle body to the subject is short, and setting the degree of emphasis to be low for regions in which it is assumed that the distance from the vehicle to the subject is far, it is possible to generate a sense of distance virtually and increase the visibility.

By setting the degree of emphasis uniformly for the entire image displayed if the vehicular speed is low and setting a higher degree of emphasis for regions to be emphasized if the vehicular speed is high, it is possible to prompt the attention of the driver, thereby contributing to driving safety.

The disclosure is not limited to the embodiment above. The above embodiment describes a case in which a sharpening process of emphasizing edges is performed as an example of the emphasis process. However, the specific method of emphasis is not limited to sharpening, and any configuration may be used as long as some regions are emphasized and other regions are blurred, or in other words, a difference in degrees of emphasis is provided.

Also, in the embodiment above, an example was described in which the display region of a full screen was divided into two sections vertically (upper section, lower section) and divided into three sections horizontally (left, center, right sections) to form six partitioned regions, and the degree of priority for sharpening and smoothing is calculated for each partitioned region to perform processing. However, the method of classifying the regions to be sharpened and smoothed is not limited to dividing the display screen into a plurality of rectangular regions in this manner. For example, a configuration may be adopted in which the display region is classified into a plurality of regions from the position corresponding to the center of the camera to positions outside thereof, and the degree of priority for sharpening and smoothing is set for each region and the corresponding processes are performed thereto.

Also, in the embodiment above, an example was described in which the degree of priority is set in advance under the assumption that, of the six partitioned regions, the lower center region typically involves distances close to the vehicle body, the upper left and right regions typically involve distances far from the vehicle body, and other regions typically involve intermediate distances from the vehicle body. However, a different configuration may be adopted in which the actual distance to the subject is measured using a ranging sensor or the like, and the degree of priority is set on the basis of the measurement results.

What is claimed is:

1. An image processing device, comprising:
an emphasis processing unit configured to generate an emphasized image yielded by performing an emphasis process on an image captured of surroundings of a vehicle;
a smoothing unit configured to generate a smoothed image yielded by performing a smoothing process on the image; and
a combination unit configured to generate, for each of a plurality of regions into which the image is divided, a display image to be displayed in a display using any of the smoothed image, the emphasized image, and the image.

2. The image processing device according to claim 1, further comprising:
a priority calculation unit configured to calculate a degree of priority of the emphasis process or the smoothing process for each of the plurality of partitioned regions into which the image is divided,
wherein the combination unit selects, for each of pixels of the plurality of partitioned regions, whether to use the smoothed image, the emphasized image, or the image based on the degree of priority, to generate the display image.

3. The image processing device according to claim 2,
wherein the priority calculation unit acquires speed information indicating a speed of the vehicle, and calculates the degree of priority based on information of a degree of emphasis of the emphasis process set in advance for each of the plurality of partitioned regions, and the speed information.

4. The image processing device according to claim 3,
wherein the information of the degree of emphasis of the emphasis process is set in advance for each of the plurality of partitioned regions based on a distance from a body of the vehicle.

5. The image processing device according to claim 1,
wherein the emphasis process is a sharpening process of emphasizing edges of the image.

6. An image processing device, comprising:
a sharpening unit configured to generate a sharpened image yielded by sharpening edges of an image captured of surroundings of a vehicle;
a priority calculation unit configured to calculate a degree of priority of the sharpening for each of a plurality of partitioned regions into which the image is divided; and
a combination unit configured to select, for each of pixels of the plurality of partitioned regions, whether to use the image or the sharpened image based on the degree of priority, to generate a display image to be displayed in a display.

7. A display device, comprising:
an image acquisition unit configured to acquire an image captured of surroundings of a vehicle;
a display unit configured to display a display image based on the image; and
an image processing unit configured to perform image processing on the image to generate the display image,
wherein the image processing unit includes:
an emphasis processing unit configured to generate an emphasized image yielded by performing an emphasis process on the image;
a smoothing unit configured to generate a smoothed image yielded by performing a smoothing process on the image; and
a combination unit configured to generate, for each of a plurality of regions into which the image is divided, the display image using any of the smoothed image, the emphasized image, and the image.
